(19) United States
(12) Patent Application Publication
(10) Pub. No.: US 2026/0307801 A1
(43) Pub. Date: Oct. 8, 2026

(54) Passenger Suite Emergency Passage Feature

(71) Applicant: Elevate Aircraft Seating LLC, Bothell, WA (US)

(72) Inventors: Max Zenon Wisniewski, Seattle, WA (US); Sahng Seok Lee, Mountlake Terrace, WA (US)

(21) Appl. No.: 19/567,862

(22) Filed: Mar. 16, 2026

Related U.S. Application Data
(60) Provisional application No. 63/784,416, filed on Apr. 7, 2025.

(51) Int. Cl. B64D 11/06; B64D 25/00

(52) U.S. Cl. CPC B64D 11/0606; B64D 25/00

(57) ABSTRACT

A passenger suite of an aircraft. The passenger suite includes a seat and a divider. The divider is positioned between the seat and a passenger aisle of the aircraft. The divider includes a first fixed partition, a second fixed partition, and a movable partition. The first fixed partition is distanced a space from the second fixed partition, the space is sized to provide ingress and egress for a passenger into and out of the passenger suite. The movable partition is movable in a planar shape between an open position and a closed position on an axis through the space between the first fixed partition and the second fixed partition. The movable partition is flexible to an arcuate shape from the closed position when acted on by a force in a direction that intersects the axis.

### CROSS-REFERENCE TO RELATED APPLICATIONS

This application claims the benefit of U.S. Provisional Patent Application Ser. No. 63/784,416, filed Apr. 7, 2025, and entitled “Frangible Door,” which is incorporated herein by reference in its entirety.

This application is related to the following U.S. patent application entitled “Passenger Suite Emergency Passage Feature,” Ser. No. ______, attorney docket no. EAS-0005-NP1, filed even date hereof, assigned to the same assignee, and incorporated herein by reference in its entirety.

### BACKGROUND INFORMATION

### 1. Field

The present disclosure relates generally to exiting a passenger suite of an aircraft. More specifically, the present disclosure relates to a passenger suite emergency passage feature that provides a secondary opening mechanism of a passenger suite of a commercial aircraft for use if a primary opening mechanism fails.

### 2. Background

Current layout of passenger suite designs adopt a standard divider separating the interior of a passenger suite of a commercial aircraft from the passenger aisle adjacent the passenger suite. The divider provides privacy for the occupants of the passenger suite while also providing a temporary/closable opening for ingress/egress to the passenger suite. The opening is typically closed off with a movable partition and may include various translation mechanisms that may include rails and hinges to accomplish moving the movable partition to allow ingress/egress of the passenger suite.

The government regulatory body that establishes national standards for qualifications of passenger suite design layouts and ensures consistent compliance with them also requires that passenger suites that include closable/movable partitions must include an emergency passage feature. The emergency passage feature is the means to escape the passenger suite in the event of failure of the passenger suite divider's primary opening mechanism. The emergency passage feature must be accessible from either side of the doorway/opening of the passenger suite. In other words, the emergency passage feature must be operable from either inside the passenger suite or from the passenger cabin aisle of the aircraft.

Therefore, it would be desirable to have a method and apparatus that takes into account at least some of the issues discussed above, as well as other possible issues.

### SUMMARY

An illustrative embodiment of the present disclosure provides a divider for a passenger suite of an aircraft. The divider includes a first fixed partition, a second fixed partition, and a movable partition. The first fixed partition is positioned between a passenger seat and a passenger aisle of the aircraft. The second fixed partition is distanced a space from the first fixed partition. The movable partition is movable in a planar shape between an open position and a closed position on an axis through the space between the first fixed partition and the second fixed partition. The movable partition hangs on a retractable cord. The movable partition is flexible to an arcuate shape from the closed position when acted on by a force in a direction that intersects the axis.

Another illustrative embodiment of the present disclosure provides a passenger suite of an aircraft. The passenger suite includes a seat and a divider. The divider is positioned between the seat and a passenger aisle of the aircraft. The divider includes a first fixed partition, a second fixed partition, and a movable partition. The first fixed partition is distanced a space from the second fixed partition, the space is sized to provide ingress and egress for a passenger into and out of the passenger suite. The movable partition is movable in a planar shape between an open position and a closed position on an axis through the space between the first fixed partition and the second fixed partition. The movable partition is reachable by the passenger seated in the seat. The movable partition hangs on a retractable cord. The movable partition is flexible to an arcuate shape from the closed position when acted on by a force in a direction that intersects the axis.

A further illustrative embodiment of the present disclosure provides a method for dividing a passenger suite of an aircraft from a passenger aisle of the aircraft. A first fixed partition and a second fixed partition are positioned between a passenger seat of the passenger suite and the passenger aisle of the aircraft. The first fixed partition is distanced a space from the second fixed partition. A movable partition is moved in a planar shape between an open position and a closed position on an axis through the space between the first fixed partition and the second fixed partition. The movable partition hangs on a retractable cord connected to the first fixed partition. The movable partition is moved in an arcuate shape from the closed position when acted on by a force in a direction that intersects the axis.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a platform in accordance with an illustrative embodiment;

FIG. 2 is an illustration of a divider of a passenger suite in an open position in accordance with an illustrative embodiment;

FIG. 3 is an illustration of a divider of a passenger suite in a closed position in accordance with an illustrative embodiment;

FIG. 4 is an illustration of a movable partition releasably connected to a fixed partition with a retractable cord in accordance with an illustrative embodiment;

FIG. 5 is an illustration of a divider of a passenger suite in an open position in accordance with an illustrative embodiment;

FIG. 6 is an illustration of a divider of a passenger suite in an open position in accordance with an illustrative embodiment;

FIG. 7 is an illustration of a divider of a passenger suite in an open position in accordance with an illustrative embodiment;

FIG. 8 is an illustration of a divider of a passenger suite in a closed position in accordance with an illustrative embodiment;

FIG. 9 is an illustration of a translation device including linear rails in accordance with an illustrative embodiment;

FIG. 10 is an illustration of a movable partition releasably connected to a fixed partition in accordance with an illustrative embodiment;

FIG. 11 is an illustration of a divider of a passenger suite in an open position in accordance with an illustrative embodiment;

FIG. 12 is an illustration of a flowchart of a process for dividing a passenger suite of an aircraft from a passenger aisle of the aircraft in accordance with an illustrative embodiment;

FIG. 13 is an illustration of a block diagram of an aircraft manufacturing and service method in accordance with an illustrative embodiment; and

FIG. 14 is an illustration of a block diagram of an aircraft in which an illustrative embodiment may be implemented.

### DETAILED DESCRIPTION

The illustrative embodiments recognize and take into account one or more different considerations. For example, the illustrative embodiments recognize and take into account that standard layouts of passenger suite designs typically include a divider that separates the passenger suite from an aircraft passenger aisle. Typical passenger suite designs include a standard opening sized for passenger ingress and egress of the passenger suite of a commercial aircraft.

The illustrative embodiments also recognize and take into account that the standard passenger suite opening typically includes some sort of movable partition incorporating a primary opening mechanism to open and close the opening in order to provide privacy.

The illustrative embodiments also recognize and take into account that the national standard for design layouts of passenger suites also requires that passenger suites that include movable partitions must include an emergency passage feature operable to escape the passenger suite in the event of failure of the passenger suite divider's primary opening mechanism.

Thus, the illustrative embodiments provide a divider of a passenger suite of a commercial aircraft that enables overriding the primary opening mechanism to provide an emergency passage feature.

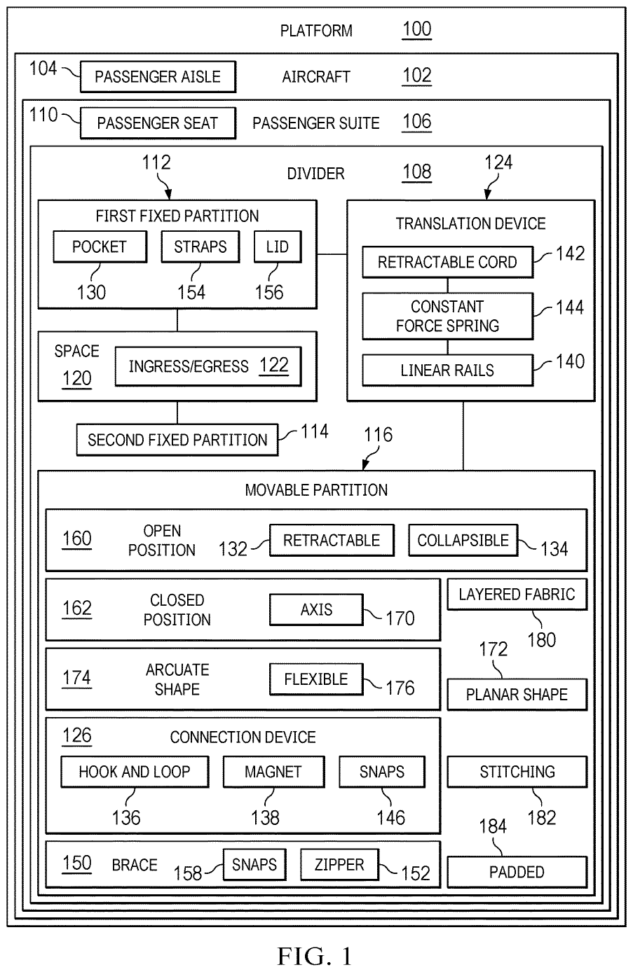

With reference now to the figures and, in particular, with reference to FIG. 1, an illustration of a block diagram of a platform is depicted in accordance with an illustrative example. Platform 100 has aircraft 102 in this illustrative example.

The illustration of aircraft 102 in FIG. 1 is not meant to imply physical or architectural limitations to the manner in which an illustrative example may be implemented. For example, although aircraft 102 may be a commercial aircraft, aircraft 102 may be a military aircraft, a rotorcraft, a helicopter, an unmanned aerial vehicle, or any other suitable aircraft that includes a door assembly.

Although the illustrative examples are described with respect to an aircraft, the illustrative example may be applied to other types of platforms. The platform may be, for example, a mobile platform, a stationary platform, a land-based structure, an aquatic-based structure, or a space-based structure. More specifically, the platform may be an aircraft, a surface ship, a tank, a personnel carrier, a train, a spacecraft, a space station, a satellite, a submarine, an automobile, a power plant, a bridge, a dam, a house, a manufacturing facility, a building, a tool, a mechanical structure, or some other suitable platform or structure where a divider with an emergency passage feature is desirable.

In this illustrative example, platform 100 takes the form of aircraft 102. In this illustrative example, when platform 100 takes the form of aircraft 102, aircraft 102 includes passenger aisle 104 and passenger suite 106. Passenger aisle 104 typically runs longitudinal along the length of aircraft 102 and leads to at least one passenger suite 106.

As used herein, a first component “connected to” or “coupled to” or “associated with” a second component means that the first component can be connected directly or indirectly to the second component. The connection is a physical association. In other words, additional components may be present between the first component and the second component. The first component is considered to be indirectly connected to the second component when one or more additional components are present between the two components. When the first component is directly connected to the second component, no additional components are present between the two components.

For example, a first component can be considered to be physically connected to a second component by at least one of being secured to the second component, bonded to the second component, mounted to the second component, welded to the second component, fastened to the second component, or connected to the second component in some other suitable manner. The first component also can be connected to the second component using a third component. The first component can also be considered to be physically connected to the second component by being formed as part of the second component, an extension of the second component, or both.

Passenger suite 106 includes divider 108 and passenger seat 110. Divider 108 separates passenger suite 106 from passenger aisle 104. Divider 108 is positioned between passenger suite 106 and passenger aisle 104. Divider 108 provides privacy to occupants of passenger suite 106 from passenger aisle 104.

Divider 108 includes first fixed partition 112, second fixed partition 114, and movable partition 116. Second fixed partition 114 is separated from first fixed partition 112 by space 120. Space 120 is an opening between first fixed partition 112 and second fixed partition 114. Space 120 is sized to provide adequate room for ingress/egress 122 of a passenger into and out of passenger suite 106.

Movable partition 116 is connected to first fixed partition 112 with translation device 124. One example of translation device 124 may be linear rails 140 connected to first fixed partition 112 within pocket 130. Brace 150 is connected to movable partition 116 with, for example, zipper 152. Other means of connecting movable partition 116 to brace 150 are also envisioned such as snaps 158. Brace 150 slides on linear rails 140. As a result, in this example, movable partition 116 slides on linear rails 140. Another example of translation device 124 may be retractable cord 142 connected to first fixed partition 112 within pocket 130. In this example, movable partition 116 is a collapsible 134 curtain with eyelets that hangs and slides on retractable cord 142. In either example, translation device 124 is connected to constant force spring 144. Constant force spring 144 urges movable partition 116 toward first fixed partition 112 to retract 132 or collapse 134 within pocket 130. Movable partition 116 is releasably connected to second fixed partition 114 with connection device 126. Examples of connection device 126 may be hook and loop fastener 136 or magnet 138 or snaps 146.

First fixed partition 112 includes pocket 130 for housing movable partition 116. Movable partition 116 may be concealed within pocket 130. Movable partition 116 is retractable 132 or collapsible 134 “accordion style” within pocket 130 of first fixed partition 112. Movable partition 116 may just retract and not be housed within a pocket of first fixed partition 112. First fixed partition 112 may include straps 154 to secure movable partition 116 to first fixed partition 112 when movable partition 116 is retracted or when collapsed within pocket 130. First fixed partition 112 may include lid 156. Lid 156 is connected to first fixed partition 112 over pocket 130. Lid 156, when affixed to first fixed partition 112, conceals movable partition 116 within first fixed partition 112.

Movable partition 116 moves between open position 160 and closed position 162. As a primary opening mechanism, translation device 124 facilitates movement of movable partition 116 between open position 160 and closed position 162. Constant force spring 144 urges movable partition 116 to open position 160. When movable partition 116 is in open position 160, space 120 allows for ingress/egress 122 of a passenger into and out of passenger suite 106. When movable partition 116 is in closed position 162, connection device 126 releasably connects movable partition 116 to second fixed partition 114. Connection device 126 is strong enough to overcome the urging of constant force spring 144 to keep movable partition 116 in closed position 162 unless movable partition 116 is acted on by a force which breaks the releasable connection of connection device 126. When the releasable connection of connection device 126 is disconnected and translation device 124 is properly operating, constant force spring 144 of translation device 124 automatically moves movable partition 116 to open position 160.

Translation device 124 provides the primary opening mechanism for divider 108. When the primary opening mechanism is operating via translation device 124, movable partition 116 moves between first fixed partition 112 and second fixed partition 114 on axis 170. Movable partition 116 moves between open position 160 and closed position 162 through space 120 on axis 170 via translation device 124. When movable partition 116 moves on axis 170, movable partition 116 has planar shape 172. When in closed position 162, movable partition 116 is generally vertically oriented and has planar shape 172. In other words, in normal operation, movable partition 116 moves between open position 160 and closed position 162 on axis 170 while shaped substantially flat or planar shape 172.

In the event of a failure of the primary opening mechanism, a secondary opening mechanism which provides an emergency passage feature is available where movable partition 116 takes on arcuate shape 174. Arcuate shape 174 is possible because movable partition 116 is flexible 176. Movable partition 116 may comprise layered fabric 180 having stitching 182. Movable partition 116 may be padded 184 on one or both lateral sides. In normal operation using the primary opening mechanism, movable partition 116 is generally vertically oriented and the lateral sides are the sides of movable partition 116 that face passenger aisle 104 and the interior of passenger suite 106.

An important aspect of divider 108 is the secondary opening mechanism which provides the emergency passage feature. If an occupant of passenger suite 106 tries to move movable partition 116 from closed position 162 to open position 160 but translation device 124 malfunctions and an occupant of passenger suite 106 needs to exit the suite, the passenger can override the primary opening mechanism provided by translation device 124 by initiating the secondary opening mechanism. To initiate the secondary opening mechanism, while movable partition 116 is in closed position 162, a force that intersects axis 170 is applied to movable partition 116. The force must be strong enough to overcome the releasable connection of movable partition 116 to second fixed partition 114 provided by connection device 126. Because movable partition 116 is flexible 176, movable partition 116 moves or bends to arcuate shape 174 as the releasable connection between movable partition 116 and second fixed partition 114 is overcome by the force applied to movable partition 116. As movable partition 116 moves to arcuate shape 174, space 120 becomes open and ingress/egress 122 of passenger suite 106 is possible even when translation device 124 malfunctions. The flexible nature of movable partition 116 to arcuate shape 174 when acted on by a force that intersects axis 170 is the secondary opening mechanism and provides an emergency passage feature.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

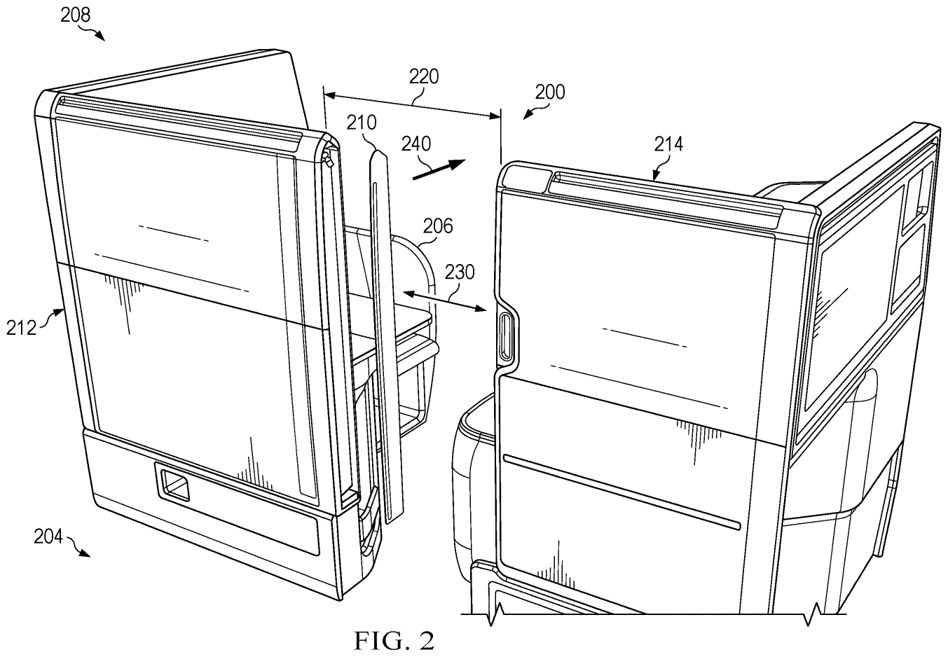

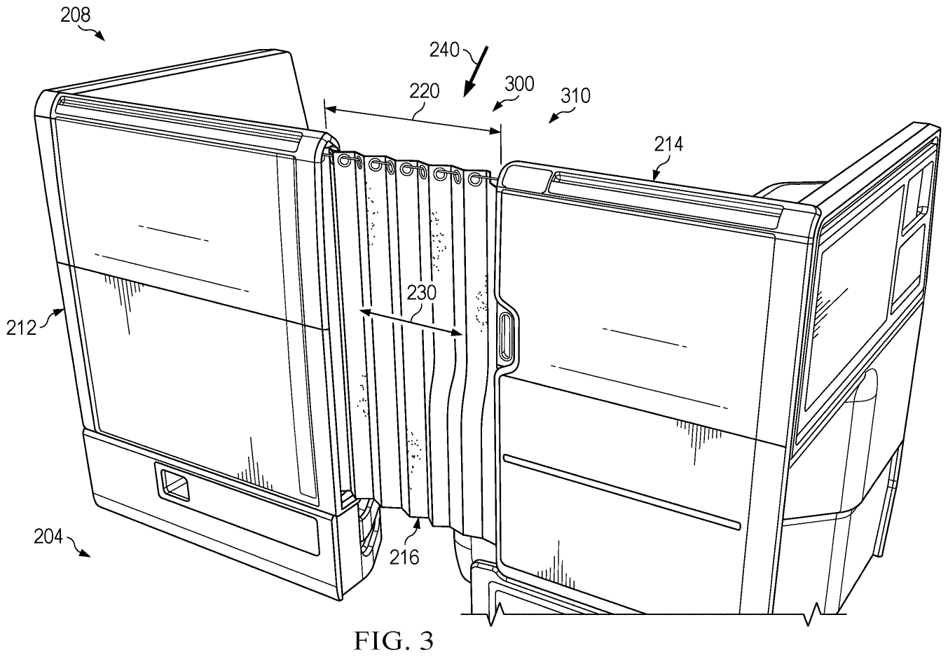

With reference next to FIGS. 2-3, illustrations of divider 208 in open position 200 and closed position 300. In these illustrative examples and the illustrative examples that follow, the same reference numeral may be used in more than one figure. This reuse of a reference numeral in different figures represents the same element in the different figures. The components illustrated in FIG. 2 are examples of physical implementations of divider 108 shown in block form in FIG. 1.

As illustrated divider 208 separates passenger suite 206 from passenger aisle 204. Divider 208 is positioned between passenger suite 206 and passenger aisle 204. Divider 208 includes first fixed partition 212, second fixed partition 214, and movable partition 216. Second fixed partition 214 is separated from first fixed partition 212 by space 220. Space 220 is an opening between first fixed partition 212 and second fixed partition 214. Space 220 is sized to provide adequate room for ingress/egress of a passenger into and out of passenger suite 206.

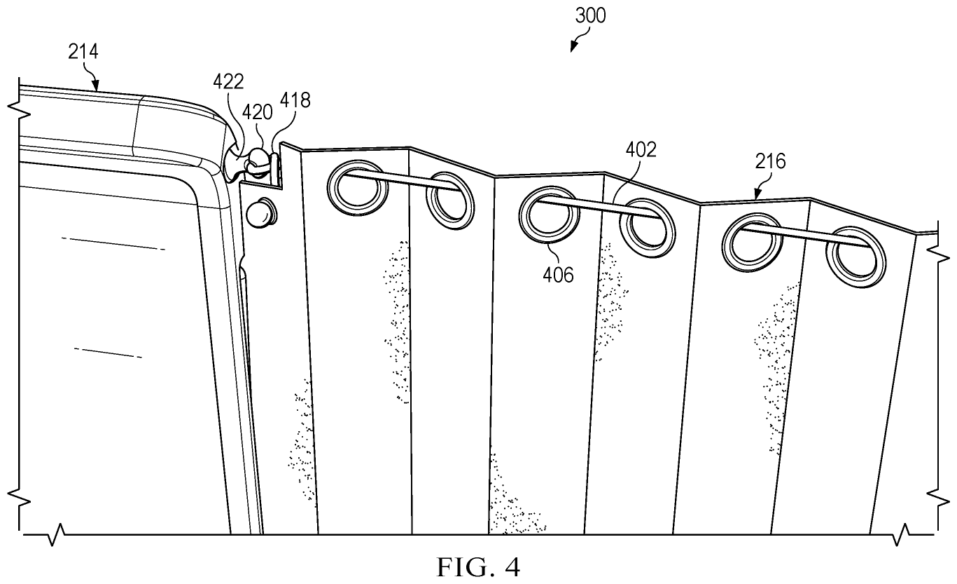

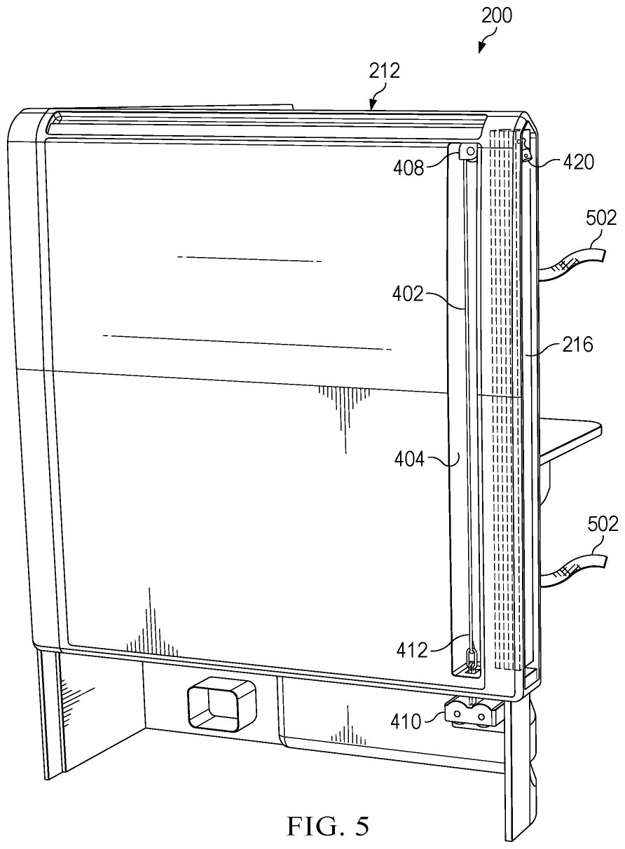

With reference next to FIGS. 4-6, illustrations of the translation device for divider 208 are depicted in accordance with an illustrative example. In this illustrative example, the translation device for divider 208 is retractable cord 402. Retractable cord 402 is connected to first fixed partition 212 within pocket 404. In this example, movable partition 216 is a collapsible curtain with eyelets 406 that hangs and slides on retractable cord 402. Retractable cord 402 is routed around pulley 408 and is connected to constant force spring 410 at end 412 of retractable cord 402. Constant force spring 410 is connected to first fixed partition 212. Constant force spring 410 urges movable partition 216 toward first fixed partition 212 to retract or collapse movable partition 216 adjacent to first fixed partition 212 or within pocket 404 of first fixed partition 212. Retractable cord 402, and thus movable partition 216, is releasably connected to second fixed partition 214 with a connection device. In this illustrative example, magnet 420 is connected to retractable cord 402 at end 418 of retractable cord 402. Magnet 420 is magnetically attracted to magnet 422 embedded within second fixed partition 214. Optionally, magnet 420 or magnet 422 may be a ferromagnetic material instead which could also provide the magnetic connection to the remaining magnet.

When in open position, movable partition 216 may be concealed within pocket 404. Movable partition 216 is retractable or collapsible within pocket 404 of first fixed partition 212. Movable partition 216 may just retract and not be housed within a pocket of first fixed partition 212. First fixed partition 212 may include straps 502 to secure movable partition 216 to first fixed partition 212 when movable partition 216 is retracted. First fixed partition 212 may include lid 210. Lid 210 is removably connected to first fixed partition 212 over pocket 404. Lid 210, when affixed to first fixed partition 212, conceals movable partition 216 within first fixed partition 212.

Movable partition 216 moves between open position 200 and closed position 300. Retractable cord 402 facilitates movement of movable partition 216 between open position 200 and closed position 300. Constant force spring 410 urges movable partition 216 to open position 200. When movable partition 216 is in open position 200, space 220 allows for the ingress/egress of a passenger into and out of passenger suite 206. When movable partition 216 is in closed position 300, retractable cord 402 and magnet 420 releasably connect movable partition 216 to second fixed partition 214. The magnetic attraction of magnet 420 to magnet 422 is strong enough to overcome the urging of constant force spring 410 to keep movable partition 216 in closed position 300 unless movable partition 216 is acted on by a force which breaks the releasable connection. It is envisioned that hook and loop fasteners could be used instead or additionally and represented by numerals 420 and 422 in the Figures as well. When the releasable connection is disconnected and retractable cord 402 is properly operating, constant force spring 410 automatically urges movable partition 216 towards first fixed partition 212 to rest at open position 200.

In this illustrative example, retractable cord 402 provides the primary opening mechanism for divider 208. Movable partition 216 moves between first fixed partition 212 and second fixed partition 214 on axis 230. Movable partition 216 moves between open position 200 and closed position 300 through space 220 on axis 230 via retractable cord 402. When movable partition 216 moves on axis 230, movable partition 216 has planar shape 310. When in closed position 300, movable partition 216 is generally vertically oriented and has planar shape 310. In other words, in normal operation, movable partition 216 moves between open position 200 and closed position 300 on axis 230 while shaped substantially flat or planar shape 310.

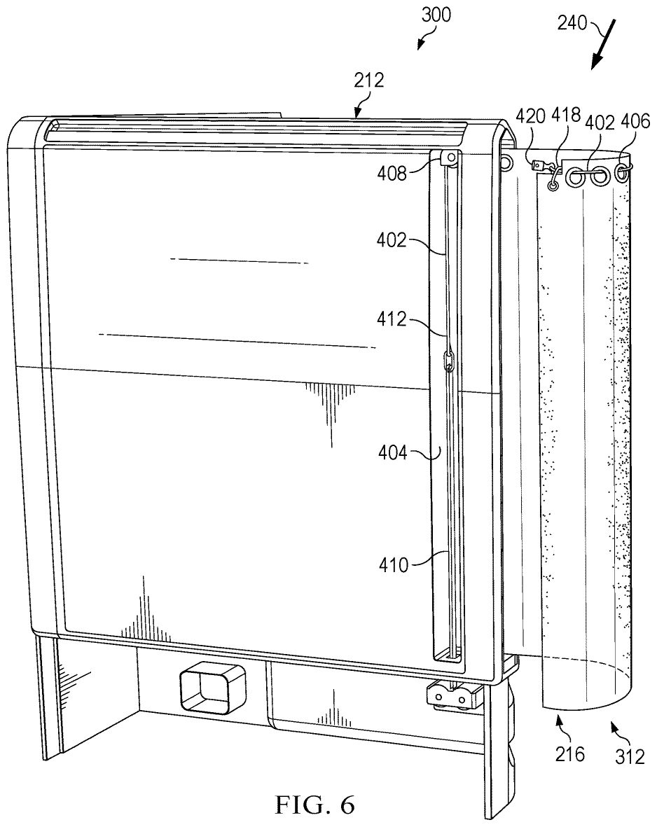

In the event of a failure of the primary opening mechanism, a secondary opening mechanism which provides an emergency passage feature is available where movable partition 216 takes on arcuate shape 312 (shown in FIG. 6). Arcuate shape 312 is possible because movable partition 216 is flexible.

To initiate the secondary opening mechanism, while movable partition 216 is in closed position 300, a force that intersects axis 230, such as force 240, is applied to movable partition 216. Force 240 must be strong enough to overcome the releasable connection of movable partition 216 to second fixed partition 214. Because movable partition 216 is flexible, movable partition 216 moves or bends to arcuate shape 312 as the releasable connection between movable partition 216 and second fixed partition 214 is overcome by force 240 applied to movable partition 216. As movable partition 216 moves to arcuate shape 312, space 220 becomes open and ingress/egress of passenger suite 206 is possible. The flexible nature of movable partition 216 to arcuate shape 312 when acted on by force 240 that intersects axis 230 is the secondary opening mechanism and provides an emergency passage feature.

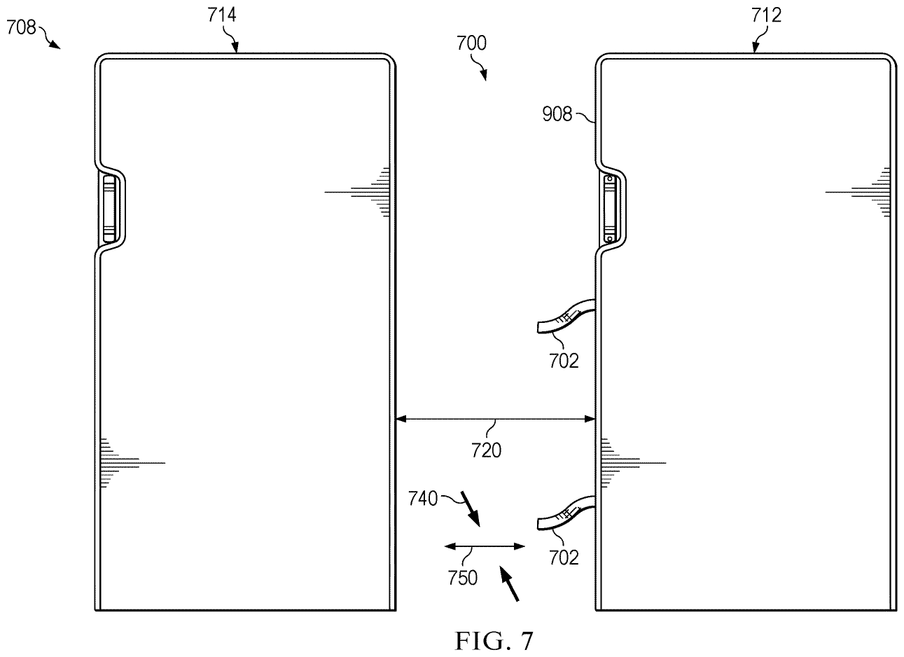

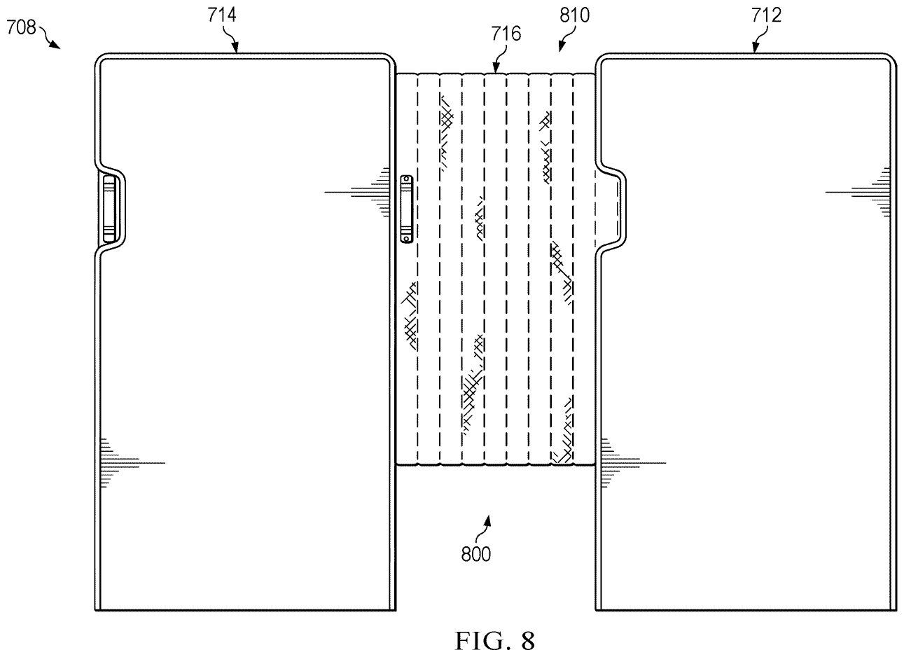

With reference next to FIGS. 7-8, illustrations of divider 708 in open position 700 and closed position 800. In these illustrative examples and the illustrative examples that follow, the same reference numeral may be used in more than one figure. This reuse of a reference numeral in different figures represents the same element in the different figures. The components illustrated in FIG. 7 are examples of physical implementations of divider 108 shown in block form in FIG. 1.

As illustrated divider 708 separates a passenger suite from a passenger aisle. Divider 708 is positioned between the passenger suite and the passenger aisle. Divider 708 includes first fixed partition 712, second fixed partition 714, and movable partition 716. Second fixed partition 714 is separated from first fixed partition 712 by space 720. Space 720 is an opening between first fixed partition 712 and second fixed partition 714. Space 720 is sized to provide adequate room for ingress/egress of a passenger into and out of the passenger suite.

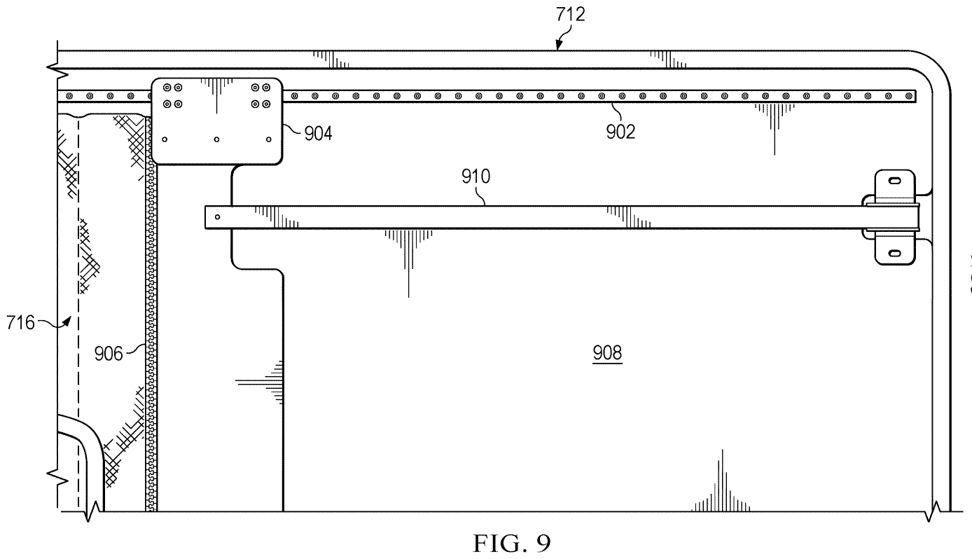

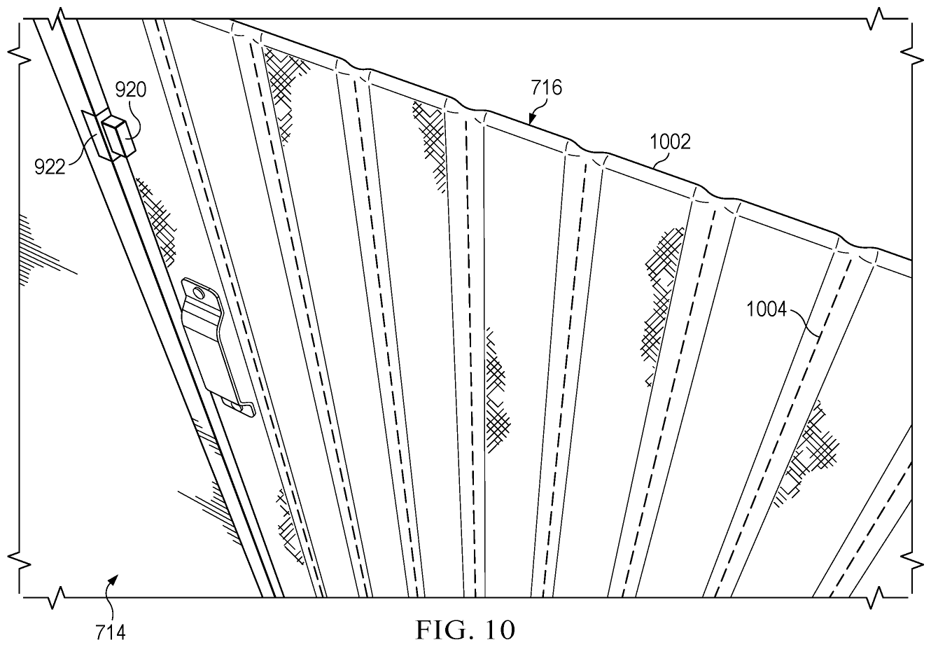

With reference next to FIGS. 9-10, an illustration of the translation device for divider 708 is depicted in accordance with an illustrative example. In this illustrative example, the translation device for divider 708 is linear rail 902. While a single linear rail is illustrated, additional linear rails may be incorporated as necessary. Linear rail 902 is connected to first fixed partition 712 within pocket 908. Brace 904 is connected to movable partition 716 with, for example, zipper 906. Brace 904 includes hardware for slidable engagement with linear rail 902. As a result, in this example, movable partition 716 slides on linear rail 902. Brace 904 is connected to constant force spring 910. Constant force spring 910 is connected to first fixed partition 712. Constant force spring 910 urges movable partition 716 toward first fixed partition 712 to retract movable partition 716 within pocket 908 of first fixed partition 712. Movable partition 716 is releasably connected to second fixed partition 714 with a connection device. In this illustrative example, magnet 920 is connected to movable partition 716. Optionally, magnet 920 may be a ferromagnetic steel rod connected to movable partition 716. Magnet 920, or the steel rod, is magnetically attracted to magnet 922 embedded within second fixed partition 714. It is envisioned that hook and loop fasteners or even snaps could be used instead of or additionally and represented by numerals 920 and 922 in the Figures as well.

When in open position, movable partition 716 is concealed within pocket 908. Movable partition 716 is retractable pocket 908 of first fixed partition 712. First fixed partition 712 may include straps 702, or any other fastening mechanism, to secure movable partition 716 to first fixed partition 712 when movable partition 716 is retracted.

Movable partition 716 moves between open position 700 and closed position 800. Linear rail 902 facilitates movement of movable partition 716 between open position 700 and closed position 800. Constant force spring 910 urges movable partition 716 to open position 700. When movable partition 716 is in open position 700, space 720 allows for the ingress/egress of a passenger into and out of the passenger suite. When movable partition 716 is in closed position 800, magnet 920 releasably connects movable partition 716 to second fixed partition 714. The magnetic attraction of magnet 920 to magnet 922 is strong enough to overcome the urging of constant force spring 910 to keep movable partition 716 in closed position 800 unless movable partition 716 is acted on by a force which breaks the releasable connection. When the releasable connection is disconnected and linear rail 902 is properly operating, constant force spring 910 automatically urges movable partition 716 towards first fixed partition 712 to rest at open position 700.

In this illustrative example, linear rail 902 provides the primary opening mechanism for divider 708. Movable partition 716 moves between first fixed partition 712 and second fixed partition 714 on axis 730. Movable partition 716 moves between open position 700 and closed position 800 through space 720 on axis 730 via linear rail 902. When movable partition 716 moves on axis 730, movable partition 716 has planar shape 810. When in closed position 800, movable partition 716 is generally vertically oriented and has planar shape 810. As the primary opening mechanism, movable partition 716 moves between open position 700 and closed position 800 on axis 730 while shaped substantially flat or planar shape 810.

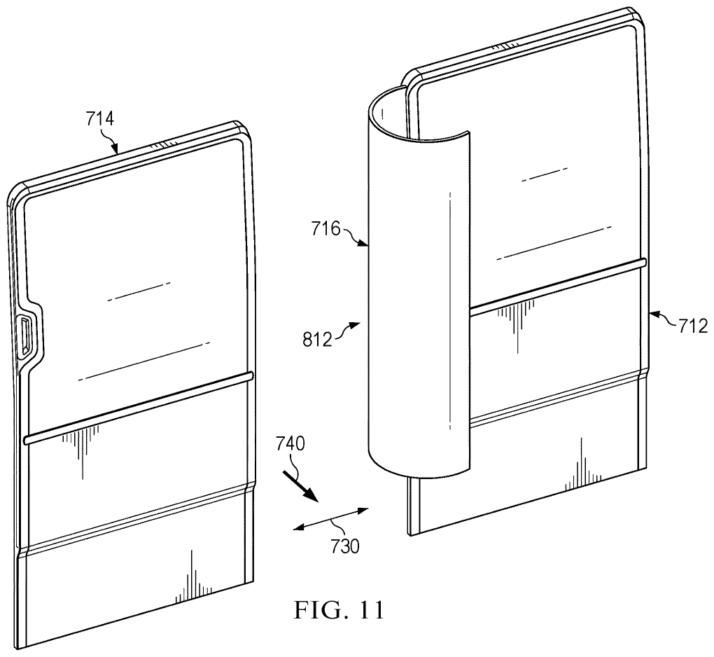

In the event of a failure of the primary opening mechanism, a secondary opening mechanism which provides an emergency passage feature is available where movable partition 716 takes on arcuate shape 812 (shown in FIG. 11). Arcuate shape 812 is possible because movable partition 716 is flexible. Movable partition 716 may comprise layered fabric 1002 having vertical stitching 1004.

To initiate the secondary opening mechanism, while movable partition 716 is in closed position 800, a force that intersects axis 730, such as force 740, is applied to movable partition 716. Force 740 must be strong enough to overcome the releasable connection of movable partition 716 to second fixed partition 714. Because movable partition 716 is flexible, movable partition 716 moves or bends to arcuate shape 812 as the releasable connection between movable partition 716 and second fixed partition 714 is overcome by force 740 applied to movable partition 716. As movable partition 716 moves to arcuate shape 812, space 720 becomes open and ingress/egress of the passenger suite is possible. The flexible nature of movable partition 716 to arcuate shape 812 when acted on by force 740 that intersects axis 730 is the secondary opening mechanism and provides an emergency passage feature.

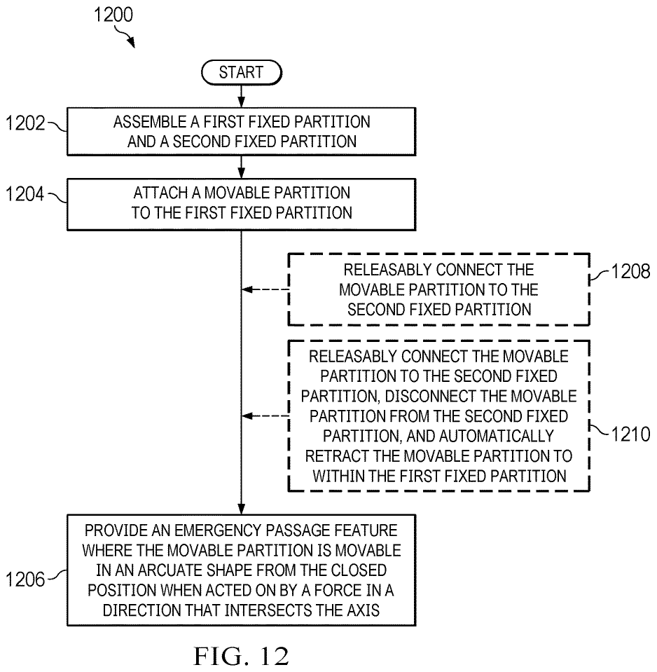

With reference next to FIG. 12, an illustration of a flowchart of a process 1200 for dividing a passenger suite of an aircraft from a passenger aisle of the aircraft is depicted in accordance with an illustrative example. The method depicted in FIG. 12 may be used in conjunction with the dividers depicted in FIGS. 1-11.

The process begins by assembling a first fixed partition and a second fixed partition between a passenger seat of the passenger suite and the passenger aisle of the aircraft (operation 1202). The first fixed partition is distanced a space from the second fixed partition. The process continues by attaching a movable partition to the first fixed partition. The movable partition is movable in a planar shape between an open position and a closed position on an axis through the space between the first fixed partition and the second fixed partition such that the movable partition is retractable in the planar shape relative to the first fixed partition (operation 1204). The movable partition is connected to the first fixed partition via a translation device. At operation 1206, the process provides an emergency passage feature where the movable partition is movable in an arcuate shape from the closed position when acted on by a force in a direction that intersects the axis such that the movable partition is retractable in the arcuate shape relative to the first fixed partition. At operation 1208, the process releasably connects the movable partition to the second fixed partition. At operation 1210, the process disconnects the movable partition from the second fixed partition and automatically retracts the movable partition to within the first fixed partition with a constant force spring connected to both the first fixed partition and the movable partition.

In some alternative implementations of an illustrative example, the function or functions noted in the blocks may not be necessary or may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

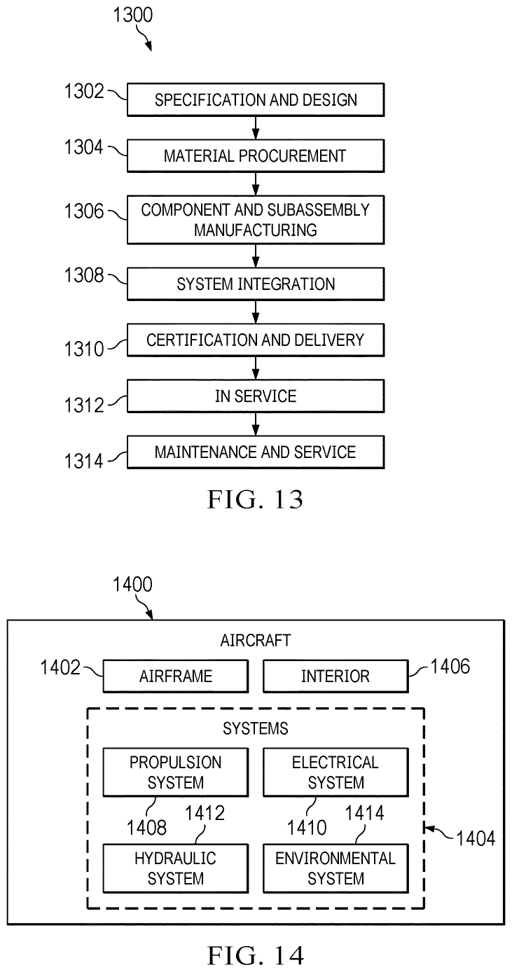

The illustrative embodiments of the disclosure may be further described in the context of aircraft manufacturing and service method 1300 as shown in FIG. 13 and aircraft 1400 as shown in FIG. 14. Turning first to FIG. 13, an illustration of a block diagram of an aircraft manufacturing and service method is depicted in accordance with an illustrative embodiment. During pre-production, aircraft manufacturing and service method 1300 may include specification and design 1302 of aircraft 1400 in FIG. 14 and material procurement 1304.

During production, component and subassembly manufacturing 1306 and system integration 1308 of aircraft 1400 in FIG. 14 takes place. Thereafter, aircraft 1400 in FIG. 14 may go through certification and delivery 1310 in order to be placed in service 1312. While in service 1312 by a customer, aircraft 1400 in FIG. 14 is scheduled for routine maintenance and service 1314, which may include modification, reconfiguration, refurbishment, and other maintenance, service, or inspection.

The apparatus of this disclosure may be installed on an aircraft during component and subassembly manufacturing 1306. In addition, the apparatus of this disclosure may be retrofitted onto aircraft 1400 in FIG. 14 during routine maintenance and service 1314 as part of a modification, reconfiguration, or refurbishment of aircraft 1400 in FIG. 14.

Each of the processes of aircraft manufacturing and service method 1300 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers, and an operator may be an airline, a leasing company, a military entity, a service organization, and so on.

With reference now to FIG. 14, an illustration of a block diagram of an aircraft is depicted in which an illustrative embodiment may be implemented. In this example, aircraft 1400 is produced by aircraft manufacturing and service method 1300 in FIG. 13 and may include airframe 1402 with plurality of systems 1404 and interior 1406. Examples of systems 1404 include one or more of propulsion system 1408, electrical system 1410, hydraulic system 1412, and environmental system 1414. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1300 in FIG. 13. In one illustrative example, components or subassemblies produced in component and subassembly manufacturing 1306 in FIG. 13 may be fabricated or manufactured in a manner similar to components or subassemblies produced while aircraft 1400 is in service 1312 in FIG. 13. As yet another example, one or more apparatus embodiments, method embodiments, or a combination thereof may be utilized during production stages, such as component and subassembly manufacturing 1306 and system integration 1308 in FIG. 13. One or more apparatus embodiments, method embodiments, or a combination thereof may be utilized while aircraft 1400 is in service 1312, during maintenance and service 1314, inclusive of inspection, in FIG. 13, or both. The use of a number of the different illustrative embodiments may substantially expedite the assembly of aircraft 1400, reduce the cost of aircraft 1400, or both expedite the assembly of aircraft 1400 and reduce the cost of aircraft 1400.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A divider for a passenger suite of an aircraft providing an emergency passage feature, comprising:
a first fixed partition configured to be positioned between a passenger seat and a passenger aisle of the aircraft;
a second fixed partition configured to be distanced a space from the first fixed partition,
a movable partition connected to the first fixed partition and movable via a translation device in a planar shape between an open position and a closed position on an axis through the space between the first fixed partition and the second fixed partition such that the movable partition is retractable in the planar shape relative to the first fixed partition; and
wherein the movable partition is flexible to an arcuate shape from the closed position when acted on by a force in a direction that intersects the axis.

2. The divider of claim 1, wherein the translation device is a linear rail connected to the first fixed partition and the movable partition.

3. The divider of claim 2, wherein the translation device further comprises:
a brace connected to an end of the movable partition, the brace slidable on the linear rail; and
a constant force spring connected to the first fixed partition and the brace.

4. The divider of claim 3, wherein the brace is connected to the movable partition with a zipper or snaps.

5. The divider of claim 1, wherein when in the open position, the movable partition is connected to the first fixed partition and when in the closed position, the movable partition is also releasably connected to the second fixed partition.

6. The divider of claim 1, wherein the first fixed partition comprises a pocket for containment of the movable partition when in the open position.

7. The divider of claim 1, wherein the space provides room for ingress/egress of a passenger into/out of the passenger suite.

8. The divider of claim 1, wherein the movable partition comprises layered fabric and stitching.

9. The divider of claim 1, wherein when in the closed position, the movable partition is releasably connected to the second fixed partition with magnets or a ferromagnetic material paired with a magnet connected to both the second fixed partition and the movable partition.

10. The divider of claim 1, wherein the movable partition is padded on a first side facing the passenger aisle and on a second side facing the passenger seat.

11. A passenger suite of an aircraft providing an emergency passage feature, comprising:
a seat; and
a divider configured to be positioned between the seat and a passenger aisle of the aircraft, the divider comprising:
a first fixed partition configured to be distanced a space from a second fixed partition, the space sized to provide ingress for a passenger into the passenger suite;
a movable partition connected to the first fixed partition and movable via a translation device in a planar shape between an open position and a closed position on an axis through the space between the first fixed partition and the second fixed partition such that the movable partition is retractable in the planar shape relative to the first fixed partition, the movable partition reachable by the passenger seated in the seat; and
wherein the movable partition is flexible to an arcuate shape from the closed position when acted on by a force in a direction that intersects the axis.

12. The passenger suite of claim 11, wherein the translation device is a linear rail connected to the first fixed partition.

13. The passenger suite of claim 12, further comprising:
a brace connected to an end of the movable partition, the brace slidable on the linear rail; and
a constant force spring connected to the first fixed partition and the brace.

14. The passenger suite of claim 13, wherein the constant force spring acts on the movable partition to urge the movable partition to the open position.

15. The passenger suite of claim 11, wherein when in the open position, the movable partition is connected to the first fixed partition and when in the closed position, the movable partition is also releasably connected to the second fixed partition.

16. The passenger suite of claim 11, wherein when the movable partition is in the open position, the movable partition is housed within a pocket of the first fixed partition.

17. A method for providing an emergency passage feature of a passenger suite of an aircraft, comprising:
assembling a first fixed partition and a second fixed partition, the first fixed partition configured to be distanced a space from the second fixed partition;
attaching a movable partition to the first fixed partition, the movable partition movable via a translation device in a planar shape between an open position and a closed position on an axis through the space between the first fixed partition and the second fixed partition such that the movable partition is retractable in the planar shape relative to the first fixed partition; and
providing an emergency passage feature where the movable partition is movable in an arcuate shape from the closed position when acted on by a force in a direction that intersects the axis.

18. The method of claim 17, wherein the movable partition is releasably connected to the second fixed partition with hook and loop fasteners connected to the movable partition and the second fixed partition.

19. The method of claim 17, wherein the movable partition is releasably connected to the second fixed partition with magnets or a magnet paired with a ferromagnetic material connected to the movable partition and the second fixed partition.

20. The method of claim 17, wherein the translation device is a linear rail and the movable partition is slidable on the linear rail connected to the first fixed partition and wherein the movable partition is retractable within the first fixed partition urged by a constant force spring connected to both the translation device and the first fixed partition when the movable partition is in both the planar shape and the arcuate shape.
